(19) United States
(12) Patent Application Publication
(10) Pub. No.: US 2009/0010805 A1
(43) Pub. Date: Jan. 8, 2009

(54) ASSAYING DEVICE AND METHOD OF TRANSPORTING A FLUID IN AN ASSAYING DEVICE

(75) Inventors: Jeffrey RAYNOR, Edinburgh (GB); Mario Scurati, Milano (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics S.r.l., Agrate Brianza (MI) (IT); STMicroelectronics (Research & Development) Limited, Marlow (GB)

(21) Appl. No.: 12/119,948

(22) Filed: May 13, 2008

(30) Foreign Application Priority Data
Jul. 2, 2007 (EP) 07270035.4

(51) Int. Cl. B01J 19/00

(52) U.S. Cl. 422/68.1

(57) ABSTRACT

An assaying device includes one or more detectors, a transporter and inlet that is connected to the one or more detectors by a one or more channels. The transporter includes one or more sealed, vacuum-containing chambers being connected to the channels, wherein each of the chambers includes an electrically activated puncture. The puncture is configured to puncture a wall of a chamber and cause a differential pressure in the one ore more channels, and thereby transport a fluid from the inlet to the one or more detectors.

### FIELD OF THE INVENTION

The present invention relates to an assaying device and a method of transporting a fluid in an assaying device.

### BACKGROUND OF THE INVENTION

Recent years have seen rapidly growing demand for biological assays for a diverse range of applications including biomedical research, disease diagnosis, food pathogen detection, environmental analysis and forensics. However, biological assays typically involve a number of steps including cell separation, cell lysis and DNA amplification. Ideally, these steps, and the actual detection of the desired biological molecules would all be performed in a single device. However, this would typically require miniaturising and connecting systems such as cytometers, separators and bioreactors, etc. Current biosensor systems include separate readers, which tend to be very expensive. Similarly, other current biosensor systems that integrate sensor elements and photodetectors, typically require the flow and control of small volumes of liquids on the surface of the device.

In recent years, attention has turned to microfluidics and methods for fabricating individual and integrated flow configurations with length scales on the order of tens and hundreds of microns. Such integrated analysis systems are known as PTAS (micro-total analysis systems) or lab-on-a-chip systems. These devices use a custom silicon processing technology which enables the construction of buried microfluidic channels. However, this technology is based solely on micro-machined silicon, and typically does not include any integrated semiconductor structures (transistors, diodes etc). Furthermore, the buried microfludic channels of such systems are not compatible with CMOS sensing structures, as they are at similar depths below the surface of the silicon.

U.S. Publication Nos. 20040141856 and 20050233440 describe analysis devices employing micropumps with various (buried) chambers and a diaphragm manufactured using a custom fabrication technology. Further, U.S. Publication No. 20050142597 describes a microreactor employing buried chambers and a sealing layer, which is perforated during use. Similarly, U.S. Publication No. 20050176037 describes an integrated microreactor for real-time polymerase chain reaction (PCR) with optical monitoring, wherein the microreactor employs buried channels into which a light beam is channelled. Further prior art includes U.S. Pat. No. 6,116,863, which describes a microactuated device driven by an electromagnetic driver, overlapping a magnetically permeable diaphragm, and European Patent Publication No. EP1403383. However, while it is possible to implement microfluidic channels and chambers on the top surface of silicon with detection underneath, the main problem resides in producing a controlled flow in the microfluidic channels.

### SUMMARY OF THE INVENTION

In view of the foregoing background, it is therefore an object of the invention to provide an assaying device and a method of transporting a fluid in an assaying device.

In contrast with the systems described in US20050176037, US20050142597, and EP1403383, whose substrate material comprises silicon only (without tubes, wherein a connection is by silicon wafer bonding) and which do not comprise any moving mechanical parts, a controlled flow in microfluidic channels by connecting the channels to a one or more sealed chambers is provided (henceforth known as vacuum chambers), each of which has a vacuum therein. In use, an opening is formed in a wall of the vacuum chamber and the vacuum causes a differential air-pressure that sucks liquid along the channel. This contrasts with the system described in U.S. Pat. No. 6,116,863, which employs electromagnetically driven vertical membrane movement to provide bi-directional fluid movement.

However, the problem remains as to how to create the opening in a wall of a vacuum chamber at the right place and at the right time. In contrast with U.S. Publication No. 20050142597, wherein such perforation is performed with a syringe, an embodiment of the present invention electrically perforates a vacuum chamber wall. While it is possible to use a fuse from poly-silicon that can be blown at the appropriate time to open a wall of a vacuum chamber, such poly-silicon fuses are not part of standard CMOS process technology. Accordingly, another embodiment of the present invention employs fuses that are part of standard CMOS process technology. Thus, in contrast with the systems described in U.S. Publication Nos. 20040141856 and 20050233440, this embodiment uses surface techniques and fuses in a standard fabrication technology.

More generally, an embodiment of the integrated assaying device is a single device which combines bio-optical detection, microfluidics, and optical sensing, using a substrate produced by a standard CMOS production technology. The integrated assaying device integrates micro-fluidics and optical sensors using standard CMOS processing technology, thereby producing a low-cost biosensor system. Further, because the photodetector in the integrated assaying device is located closer to any chemical reactions occurring in the microfluidic chambers, the sensitivity of the detection process is increased.

### BRIEF DESCRIPTION OF THE DRAWINGS

Several embodiments of the present invention will herein be described by way of example only with reference to the accompanying Figures in which:

FIG. 1 is plan view of a first embodiment of an assaying device in accordance with the present invention;

FIG. 2 is a cross-sectional view, along the line X-X, of a surface microfluidic chamber in the first embodiment of the assaying device shown in FIG. 1;

FIG. 3 is a cross-sectional view of a second embodiment of the assaying device in accordance with the present invention;

FIG. 4 is a plan view of a vacuum chamber in the second embodiment of the assaying device shown in FIG. 3;

FIG. 5 is a cross-sectional view of a vacuum pump fuse before use, in the vacuum chamber shown in FIG. 4, along the line A-A′;

FIG. 6 is a cross-sectional view of a vacuum pump fuse in the vacuum chamber shown in FIG. 4, showing a first method of transporting a fluid in an assaying device;

FIG. 7 is a cross-sectional view of a vacuum pump fuse in the vacuum chamber shown in FIG. 4, showing a second method of transporting a fluid in an assaying device; and

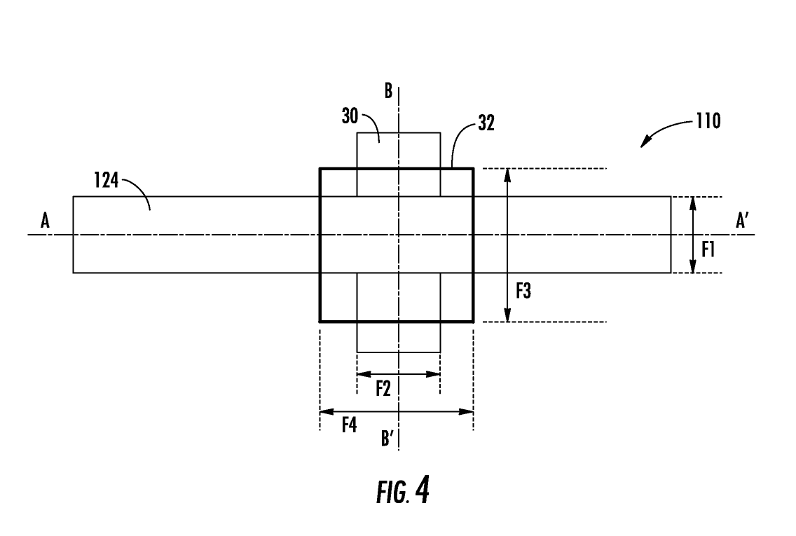

Table 1 details the dimensions of various elements of the vacuum chamber shown in FIG. 4.

### DETAILED DESCRIPTION OF THE PREFERRED EMBODIMENTS

### First Embodiment Vacuum Chamber with Polysilicon Fuses

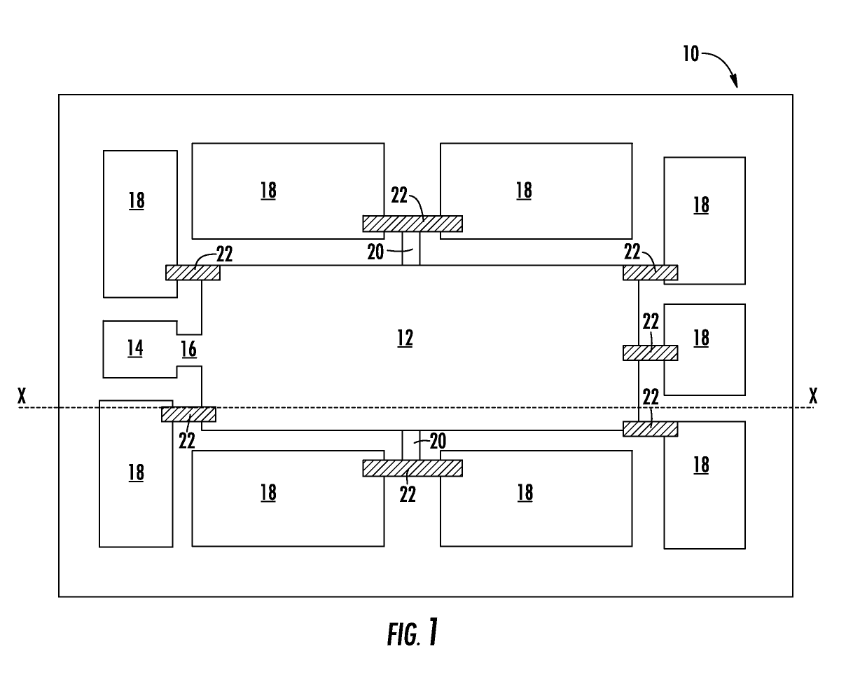

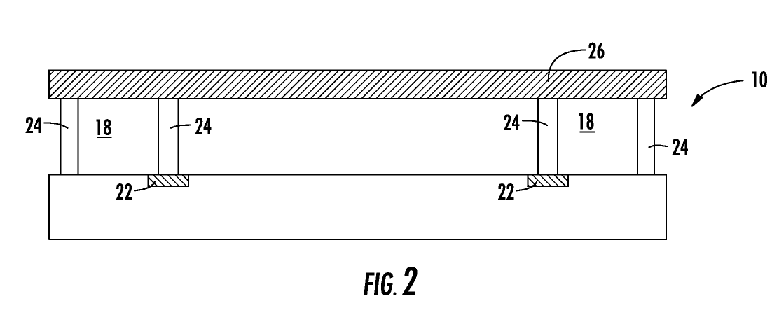

Referring to FIG. 1, the assaying device 10 comprises a central photosensor 12 connected to an inlet 14 through a channel 16. The photosensor 12 is also connected to a plurality of vacuum chambers 18 through channels 20 with intervening fuses 22. Referring to FIG. 2, the vacuum chambers 18 are formed, by the deposition/formation of polymer walls 24 on the surface of the assaying device 10 during fabrication. The assaying device 10 is then sealed under vacuum with a tape 26. While it is possible to seal the entire surface of the assaying device 10 (i.e. including the inlet 14) with the intention of having the tape 26 pierced during operation, it is also possible to include a hole in the tape 26 during fabrication to allow entry of a syringe/pipette therein. If the device is not to be pierced, the top layer could be something more substantial—e.g. glass (with an entry hole) or even silicon (again with entry hole). Silicon is attractive as it has the same thermal co-efficient of expansion as the substrate material.

In use, a user introduces a fluid sample to the inlet 14 and the assaying device 10 is connected to power and/or controller system not shown, which may or may not be integrated onto the assaying device 10. In accordance with a pre-defined sequence and timing, the controller then passes current through one or more of the polysilicon fuses 22 causing them to rupture and break the seal on their corresponding vacuum chambers 18. The force of the vacuum/air pressure released by the controlled blowing of the fuses 22 drives and controls the flow of the sample fluid over the surface of the photosensor 12, thereby ensuring smooth and even distribution of the sample on the photosensor 12.

### Second Embodiment: Vacuum Pump with Metal Fuses

An advantage of the first embodiment is that polysilicon fuses typically have relatively high resistances. Accordingly, such fuses absorb and dissipate energy easily and are easily blown. However, while polysilicon fuses are fairly common in standard CMOS processes, they are usually located very close to the surface of the silicon in an integrated circuit. Further, the layers (metal and inter-metal dielectric) disposed above the fuses, prevent their use to allow the passage of gas/air.

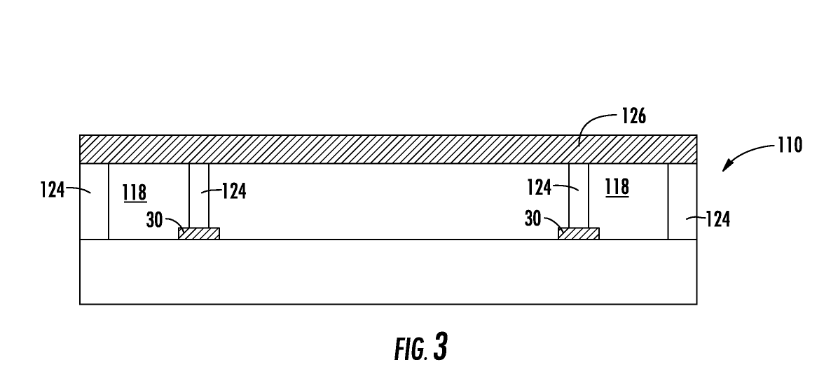

Referring to FIG. 3, a second embodiment of the assaying device 110, comprises the same basic structural features of the vacuum chambers used in the first embodiment. However, in contrast with the first embodiment, the second embodiment uses thin sections of a top metal 30 in its vacuum chambers and one or more openings in an overglass (silicon oxide/silicon nitride/phosphosilicate) that covers the device 110. Such openings are a standard feature on all silicon devices, wherein the openings are normally located over the devices' bond-pads to enable electrical connection therewith. However, in the second embodiment, an opening in the overglass is located over a top metal section 30 in a vacuum chamber.

This arrangement is unusual because normal design rules for ICs would typically teach against the placement of such openings at places other than bond-pads. In particular, an overglass is normally used to protect a device, especially the top metal from damage, during packaging/assembly of the device, and to prevent moisture ingress, which would otherwise lead to corrosion of the metal or delamination of the device. These factors would seriously affect the reliability of the IC. However, in the present case, overglass openings are protected by the polymer. Furthermore, the device is a single-use device, and its shelf time is usually limited by the bio-chemical assays used.

In particular, referring to FIG. 4, the opening 32, which may be, for example, rectangular in shape, is formed over the intersection of the top-layer metal 30 and the polymer walls 124 of the vacuum chamber. The dimensions of the opening 32 are not critical (i.e. the manufacturing tolerances of such openings when included in a standard silicon device are relatively coarse). Referring to table 1, typically, the width (F4) and height (F3) of the pad opening is 10 μm-60 μm. In modern CMOS process technologies, copper is typically used as a conductor in some or part of the metal interconnection. However, in other process technologies, aluminium is used. The above process of locating an opening in the overglass over a top metal layer can be used with either aluminium or copper top-level layers. In the following example, the top layer metal is made from aluminium. However, it will be appreciated that the second embodiment is not limited to this top layer metal, and in particular, the second embodiment could employ any suitable top layer metal.

It is common for the top layers of metal to be used for power/ground conduction. To reduce voltage drops across the top metal layers, their resistivity is typically low, since they are often thicker than the other metal layers in the process technology. Low resistivity is usually an advantage for a conductor, but in the second embodiment of the assaying device, the top layer metal is used as a fuse/heating element. Hence, having a higher resistivity is beneficial. To achieve such higher resistivity, it may be advantageous to thin the top metal in the area in which it is to be used as a fuse (henceforth known as a fuse area). In particular, the metal conductor is generally made as thin as possible (dimension F2). With the inclusion of an opening in the overglass over the intersection of the polymer walls of a vacuum chamber and its metal fuse, the top layer metal is now exposed in the fuse area. However, the non-removed overglass can be used as a barrier to prevent the etching of the conductors outside the fuse area.

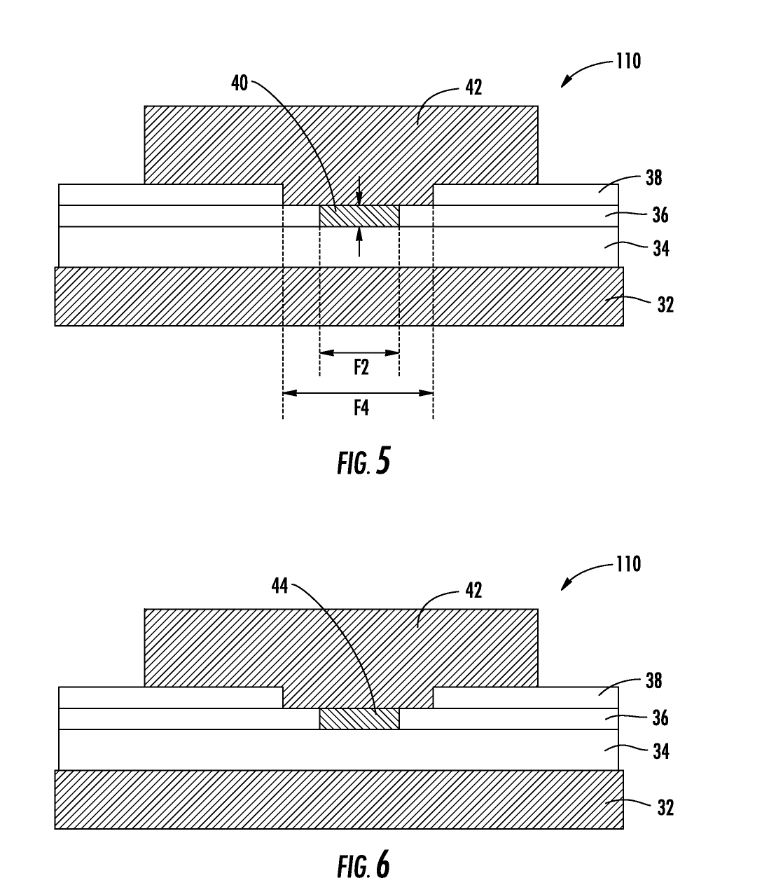

Referring to FIG. 5, an exemplary vacuum chamber in the second embodiment of the assaying device comprises a silicon substrate 32 coated with a layer 34 of metal and dielectric. The metal and dielectric layer 34 is in turn coated with a dielectric top metal layer 36, with an embedded aluminium fuse 40. The dielectric top metal layer 36 is in turn coated with a silicon oxide and nitride overglass 38, which is typically about 900 nm thick. The, silicon oxide and nitride overglass 38 is provided with an opening therethrough, wherein the opening is located over the dielectric top metal layer 36 and is filled with a polymer plug 42. The opening in the silicon oxide and nitride overglass 38 is larger than the aluminium fuse 40. Thus, before the vacuum pump of the assaying device 110 is activated, the polymer plug 42 is in contact with the aluminium fuse 40 and the dielectric top metal layer 36. Outside the fuse area, the polymer plug 42 is in contact with the silicon oxide and nitride overglass 38. As a result, the polymer plug 42, top metal layer 36 and aluminium fuse 40 form an impenetrable barrier over the assaying device.

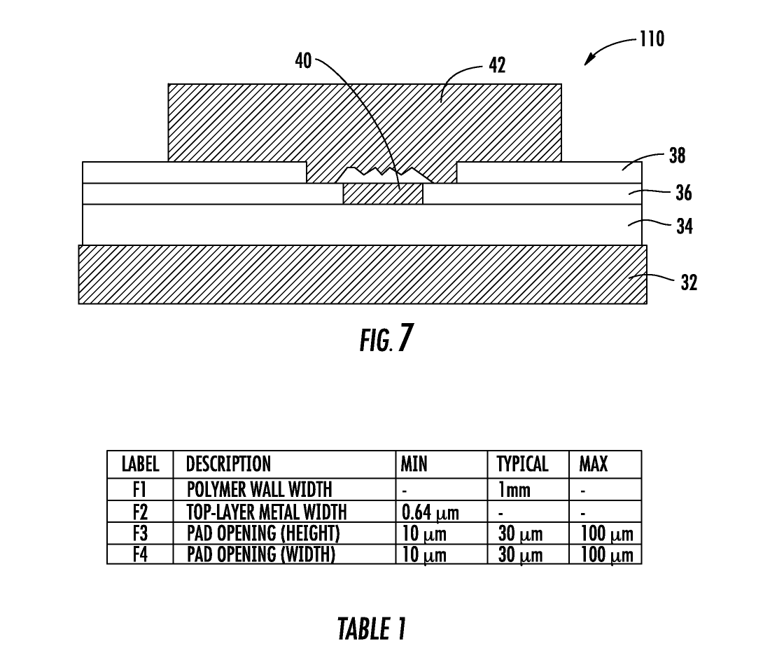

For the second embodiment of the assaying device 110 to detect an analyte, a sample fluid flows over the surface of the assaying device's photodetector (not shown). This flow is achieved using the differential air pressure formed when the fuse in one of the second embodiment's vacuum chambers is opened. There are various mechanisms for opening the fuse. The first is shown in FIG. 6, wherein a high current is passed through the dielectric top metal layer 36 to the aluminium fuse 40. The high current causes the metal of the aluminium fuse 40 to heat up. In particular, since the aluminium fuse 40 has a very small volume, the heat generated by the high current is sufficient to cause the aluminium fuse 40 to melt and possibly evaporate. The melting process opens a channel between the polymer plug 42 and the silicon substrate 32, forming a void 44 therebetween. The void 44 advantageously allows the passage of air into the vacuum chamber, and the resulting differential air pressure causes the fluid sample to flow.

Another technique is illustrated in FIG. 7. In common with the previous technique, a high current is passed through the dielectric top metal layer 36 to the aluminium fuse 40, which causes it to heat up. The heat of the aluminium fuse 40 is transferred to the polymer plug 42, which causes it to deform (e.g. melt). The deformation of the polymer plug 42 produces a void in the above-mentioned impenetrable barrier and allows the passage of air/gas into the vacuum chamber, thereby producing a differential air pressure in the assaying device 110, and causing the fluid sample to flow.

While both of the above techniques cause the creation of a void, as a result of the thermal resistance between the aluminium fuse 40 and the polymer plug 42, a shorter, higher-current pulse on the aluminium metal fuse 40 is likely to cause the metal conductor to melt/evaporate, whereas, a longer, lower-current pulse on the aluminium fuse 40 is more likely to cause the polymer plug 42 to deform. Since both techniques require the flow of high currents, it is desirable to have all the wiring for the aluminium fuse 40 on a single layer (i.e. the dielectric top metal layer 36). This avoids the formation of interconnections between layers, or vias, which tend to have high resistivity, and would be more likely to blow than the fuses.

Modifications and alterations may be made to the above without departing from the scope of the present invention.

1-16. (canceled)

17. An assaying device comprising:
at least one detector;
an inlet;
at least one channel coupling said inlet and said at least one detector; and
at least one sealed vacuum chamber coupled to said at least one channel, and comprising
a wall, and
an electrically activated puncturing device to puncture said wall and cause a differential pressure in said at least one channel and thereby transport a fluid from the inlet to the at least one detector.

18. The assaying device as in claim 17, wherein said electrically activated puncturing device comprises a fuse.

19. The assaying device as in claim 18, further comprising a current supply to supply a current to said fuse.

20. The assaying device as in claim 19, further comprising a controller in communication with said current supply to control said fuse.

21. The assaying device as in claim 18, wherein said fuse comprises polysilicon.

22. The assaying device as in claim 18, wherein said at least one sealed vacuum chamber comprises a base adjacent said wall; and wherein said fuse is embedded in said base at an intersection with said wall.

23. The assaying device as in claim 18, wherein said fuse comprises a metal.

24. The assaying device as in claim 13, wherein said at least one sealed vacuum chamber comprises a base adjacent said wall; and wherein said fuse is on top of said base at an intersection with said wall.

25. The assaying device as in claim 17, further comprising an overglass covering said at least one detector, said inlet, said at least one channel, and said at least one vacuum chamber.

26. The assaying device as in claim 25, wherein said at least one sealed vacuum chamber comprises a base adjacent said wall; and wherein said overglass has an opening therein over an intersection of said base and said wall.

27. A diagnostic system comprising:
an assaying device comprising
at least one detector,
an inlet,
at least one channel coupling said inlet and said at least one detector and
at least one sealed vacuum chamber coupled to said at least one channel, and comprising
a wall, and
an electrically activated puncturing device to puncture said wall and cause a differential pressure in said at least one channel and thereby transport a fluid from the inlet to the at least one detector.

28. A diagnostic system according to claim 27, wherein the diagnostic system comprises a food testing system.

29. A diagnostic system according to claim 27, wherein the diagnostic system comprises a pharmaceutical testing system.

30. A method of making an assaying device comprising:
forming at least one channel between an inlet and at least one detector; and
forming at least one vacuum chamber coupled to the at least one channel and comprising
a wall, and
an electrically activated puncturing device to puncture the wall and cause a differential pressure in the at least one channel and thereby transport a fluid from the inlet to the at least one detector.

31. The method as in claim 30, wherein the electrically activated puncturing device comprises a fuse.

32. The method as in claim 31, further comprising providing a current supply to supply a current to the fuse.

33. The method as in claim 32, further comprising providing a controller in communication with the current supply to control the fuse.

34. The method as in claim 31, wherein the fuse comprises polysilicon.

35. The method as in claim 31, wherein the at least one sealed vacuum chamber comprises a base adjacent the wall; and wherein the fuse is embedded in the base at an intersection with the wall.

36. The method as in claim 31, wherein the fuse comprises a metal.

37. The method as in claim 31, wherein the at least one sealed vacuum chamber comprises a base adjacent the wall; and wherein the fuse is on top of the base at an intersection with the wall.

38. The method as in claim 30, further comprising covering the at least one detector, the inlet, the at least one channel, and the at least one vacuum chamber with an overglass.

39. The method as in claim 38, wherein the at least one sealed vacuum chamber comprises a base adjacent the wall; and wherein the overglass has an opening therein over an intersection of the base and the wall.
